(19) United States
(12) Patent Application Publication
(10) Pub. No.: US 2025/0201880 A1
(43) Pub. Date: Jun. 19, 2025

(54) FUEL CELL SYSTEM

(71) Applicant: TOYOTA JIDOSHA KABUSHIKI KAISHA, Toyota-shi (JP)

(72) Inventors: Atsuo IIO, Nagoya-shi (JP); Kazuo YAMAMOTO, Toyota-shi (JP); Keisuke YOKOTA, Nisshin-shi (JP); Morio SHINODA, Anjo-shi (JP)

(21) Appl. No.: 18/969,469

(22) Filed: Dec. 5, 2024

(30) Foreign Application Priority Data
Dec. 19, 2023 (JP) 2023-213499

(51) Int. Cl. H01M 8/04701; H01M 8/0432

(52) U.S. Cl. CPC H01M 8/04723; H01M 8/04358

(57) ABSTRACT

To provide a fuel cell system configured to increase efficiency. A fuel cell system, wherein the fuel cell system comprises a fuel cell, a cooling system and a control device; wherein the cooling system comprises a cooling water pump and a reserve tank; wherein, when a temperature of cooling water is equal to or lower than a low-temperature determination threshold value, the control device is configured to perform temperature increase control for increasing the temperature of the cooling water to a target temperature; wherein, after the temperature increase control, the control device is configured to cool the temperature of the cooling water to a normal use temperature lower than the target temperature; and wherein the target temperature is set based on at least one of a pressure resistance of the cooling system or an operating pressure of the reserve tank.

### TECHNICAL FIELD

The present disclosure relates to a fuel cell system.

### BACKGROUND

Various studies have been proposed for fuel cells (FC) as disclosed in Patent Documents 1 and 2.
Patent Document 1: Japanese Patent Application Laid-Open (JP-A) No. 2005-150018
Patent Document 2: JP-A No. 2004-296326

Patent Literature 1 discloses a fuel cell system in which the upper limit flow rate of cooling water is controlled to be less than or equal to the pressure resistance of a cooling system, by calculating the upper limit flow rate of the cooling water based on the opening degree of a three-way valve, calculating the target flow rate of the cooling water according to the power generation amount of a fuel cell, and driving a cooling water pump (W/P) based on these calculation results.

It is necessary to control the flow rate of the cooling water so as not to exceed the pressure resistance of the cooling system. As a result, it is necessary to suppress the power generation amount of the fuel cell due to the fact that the cooling water does not flow at the desired flow rate, and there is a possibility that the power required by the fuel cell system cannot be met.

Increasing the pressure resistance of the cooling system results in an increase in cost and an increase in system size, thereby reducing the user's degree of freedom in design.

When the pressure resistance of the cooling system is not increased, in order to maintain a desired fuel cell power generation amount, the pressure of a fuel gas system and that of an oxidizing gas system need to be higher than that of the cooling system, and reaction gas needs to be excessively supplied to the fuel cell. As a result, the efficiency of the fuel cell system is reduced.

### SUMMARY

The disclosure was achieved in light of the above circumstances. An object of the disclosure is to provide a fuel cell system configured to increase efficiency.

That is, the present disclosure includes the following embodiments.

<1>A fuel cell system,
wherein the fuel cell system comprises a fuel cell, a cooling system and a control device;
wherein the cooling system comprises a cooling water pump and a reserve tank;
wherein, when a temperature of cooling water is equal to or lower than a low-temperature determination threshold value, the control device is configured to perform temperature increase control for increasing the temperature of the cooling water to a target temperature;
wherein, after the temperature increase control, the control device is configured to cool the temperature of the cooling water to a normal use temperature lower than the target temperature; and
wherein the target temperature is set based on at least one of a pressure resistance of the cooling system or an operating pressure of the reserve tank.

<2>The fuel cell system according to <1>,
wherein the control device is configured to monitor a temperature history of the temperature of the cooling water, and
wherein, when the temperature history becomes equal to or lower than the low-temperature determination threshold value, the control device is configured to perform the temperature raising control.

The fuel cell system of the present disclosure can increase efficiency.

### BRIEF DESCRIPTION OF THE DRAWINGS

In the accompanying drawings,

FIG. 1 is a graph showing a relationship between the temperature of cooling water and the pressure in a cooling system;

FIG. 2 is a flowchart illustrating an example of control of the fuel cell system of the present disclosure; and

FIG. 3 is a flowchart illustrating another example of control of the fuel cell system of the present disclosure.

### DETAILED DESCRIPTION

Hereinafter, the embodiments of the present disclosure will be described in detail. Matters that are required to implement the present disclosure (such as common a fuel cell system structures and production processes not characterizing the present disclosure) other than those specifically referred to in the Specification, may be understood as design matters for a person skilled in the art based on conventional techniques in the art. The present disclosure can be implemented based on the contents disclosed in the Specification and common technical knowledge in the art.

In addition, dimensional relationships (length, width, thickness, and the like) in the drawings do not reflect actual dimensional relationships.

In the present disclosure, a reaction gas supplied to the anode of the fuel cell is a fuel gas (anode gas), and the reaction gas supplied to the cathode of the fuel cell is an oxidant gas (cathode gas). The fuel gas is a gas mainly containing hydrogen, and may be hydrogen. The oxidant gas is a gas containing oxygen, and may be oxygen, air, or the like.

In the present disclosure, there is provided a fuel cell system,
wherein the fuel cell system comprises a fuel cell, a cooling system and a control device;
wherein the cooling system comprises a cooling water pump and a reserve tank;
wherein, when a temperature of cooling water is equal to or lower than a low-temperature determination threshold value, the control device is configured to perform temperature increase control for increasing the temperature of the cooling water to a target temperature;
wherein, after the temperature increase control, the control device is configured to cool the temperature of the cooling water to a normal use temperature lower than the target temperature; and
wherein the target temperature is set based on at least one of a pressure resistance of the cooling system or an operating pressure of the reserve tank.

In general control, the fuel cell is operated by setting the cooling water to a uniform target temperature. On the other hand, in the present disclosure, the target temperature of the cooling water is made variable.

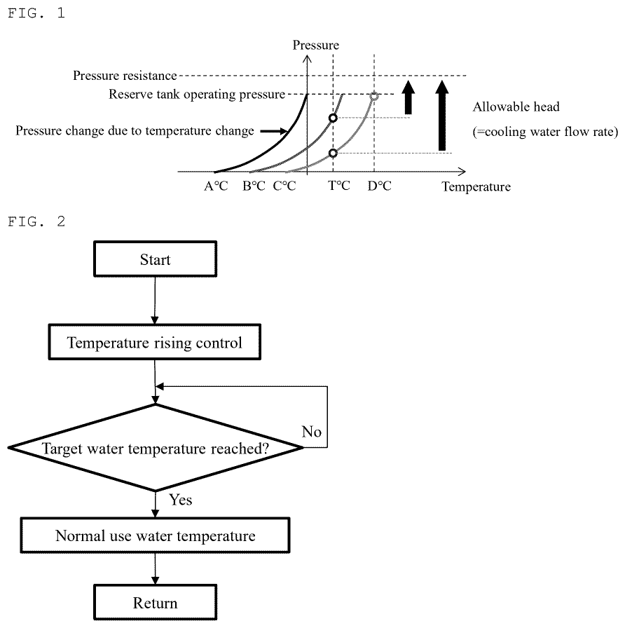

FIG. 1 is a graph showing a relationship between the temperature of cooling water and the pressure in a cooling system.

The temperature of the cooling water increases with the generation of heat of the fuel cell due to the operation of the fuel cell. Then, the outlet pressure of the cooling water pump increases in accordance with the flow rate of the cooling water driven by the cooling water pump. For example, when the temperature of the cooling water is equal to or lower than the low-temperature determination threshold A° C., when the fuel cell is operated as it is, the pressure in the cooling system reaches the operating pressure of the reserve tank before the temperature of the cooling water reaches the normal use temperature T° C. When the fuel cell is operated when the temperature of the cooling water is B° C. or C° C., the pressure in the cooling system does not reach the operating pressure of the reserve tank even if the temperature of the cooling water reaches the normal use temperature T° C., but the output of the cooling water pump must be limited. Therefore, the temperature of the cooling water is intentionally raised to D° C., which is the target temperature, without operating the fuel cell and without changing the pressure in the cooling system. The target temperature is higher than the normal use temperature T° C. of the cooling water, and is a temperature in consideration of at least one of the withstand pressure of the cooling system and the operating pressure of the reserve tank. Thereafter, the temperature of the cooling water is cooled to the normal use temperature T° C., and the fuel cell is operated.

Thus, even when the cooling water pump is driven, the pressure in the cooling system does not exceed the withstand pressure of the cooling system.

Therefore, according to the present disclosure, it is possible to maintain the cooling system so as not to exceed the withstand pressure of the cooling system without limiting the operating range of the cooling water pump.

Further, by the temperature rise control of the present disclosure, it is not necessary to perform the pressure resistance design assuming the worst case, it is possible to reduce the cost of the cooling system, it is possible to supply the cooling water of a desired flow rate to the fuel cell, it is also possible to avoid the power generation restriction of the fuel cell.

In the present disclosure, it is possible to maintain the cooling system so as not to exceed the withstand pressure of the cooling system without limiting the operating range of the cooling water pump.

In the present disclosure, unnecessary temperature rise control of the cooling water can be avoided.

The fuel cell system of the present disclosure may be mounted on a moving body such as a vehicle and used. Further, the fuel cell system of the present disclosure may be mounted in a stationary power generation system such as a generator that supplies electric power to the outside of the fuel cell system.

The vehicle may be a fuel cell vehicle or the like. Examples of the moving body other than the vehicle include a railway, a ship, and an aircraft.

Further, the fuel cell system of the present disclosure may be mounted on a moving body such as a vehicle capable of traveling even with electric power of a secondary battery.

The mobile body and the stationary power generation system may include the fuel cell system of the present disclosure. The moving body may include a drive unit such as a motor, an inverter, and a hybrid control system.

The hybrid control system may be capable of driving a moving body by using both the output of the fuel cell and the electric power of the secondary battery.

The fuel cell system includes a fuel cell in which hydrogen and oxygen react to generate electricity, a control device, and a cooling system that supplies cooling water for cooling heat generated by electricity generation to the fuel cell. The fuel cell system may include a fuel gas system that supplies a fuel gas containing hydrogen necessary for power generation of the fuel cell to the fuel cell, an oxidant gas system that supplies an oxidant gas containing oxygen to the fuel cell, and the like.

The fuel cell system includes a fuel cell.

The fuel cell may be a fuel cell stack that is a stacked body in which a plurality of unit cells of a fuel cell are stacked.

In the present disclosure, both the unit cell and the fuel cell stack may be referred to as a fuel cell.

The number of stacked unit cells in the fuel cell stack is not particularly limited, and may be, for example, 2 to several hundred.

The fuel cell stack may include a current collector plate, a pressure plate, and the like at an end portion in the stacking direction.

The unit cell may include a power generation unit.

The shape of the power generation unit may be a rectangular shape in a plan view.

The power generation unit may be a membrane electrode assembly (MEA) including an electrolyte membrane and two electrodes.

The electrolyte membrane may be a solid polymer electrolyte membrane. Examples of the solid polymer electrolyte membrane include a fluorine-based electrolyte membrane such as a thin film of perfluorosulfonic acid containing moisture, and a hydrocarbon-based electrolyte membrane. The electrolyte membrane may be, for example, a Nafion membrane (manufactured by DuPont).

The two electrodes are one anode (fuel electrode) and the other cathode (oxidant electrode).

The electrode includes a catalytic layer, and may optionally include a gas diffusion layer, and the power generation unit may be a membrane electrode gas diffusion layer assembly (MEGA).

The catalyst layer may include a catalyst, and the catalyst may include a catalyst metal that promotes an electrochemical reaction, an electrolyte having proton conductivity, a support having electron conductivity, and the like.

As the catalytic metal, for example, platinum (Pt) and an alloy composed of Pt and another metal (for example, a Pt alloy obtained by mixing cobalt, nickel, and the like) can be used. The catalyst metal used as the cathode catalyst and the catalyst metal used as the anode catalyst may be the same or different.

The electrolyte may be a fluorine-based resin or the like. As the fluorine-based resin, for example, a Nafion solution or the like may be used.

The catalyst metal may be supported on a support, and in each of the catalyst layers, a support (catalyst-supported support) on which the catalyst metal is supported and an electrolyte may be mixed.

Examples of the support for supporting the catalyst metal include carbon materials such as carbon, which are generally commercially available.

The gas diffusion layer may be a conductive member or the like having pores.

Examples of the conductive member include a carbon porous body such as carbon cloth and carbon paper, and a metal porous member such as a metal mesh and a metal foam.

The unit cell may include a separator.

The separator collects current generated by power generation and functions as a partition wall. The separator is usually disposed on both sides of the unit cell in the stacking direction of the power generation unit such that a pair of separators sandwich the power generation unit. One of the pair of separators is an anode separator and the other is a cathode separator.

The anode separator may have a groove that serves as a fuel gas flow path on a surface on the side of the power generation unit.

The cathode separator may have a groove that serves as an oxidant gas flow path on a surface on the side of the power generation unit.

The separator may have holes constituting a manifold such as a supply hole and a discharge hole for allowing fluid to flow in the stacking direction of the unit cells.

The separator may be, for example, dense carbon obtained by compressing carbon to make it impermeable to gas, and press-formed metal (for example, iron, titanium, stainless steel, and the like).

The unit cell may include an insulating resin frame disposed on the outer side (outer periphery) in the surface direction of the membrane electrode assembly between the anode separator and the cathode separator. The resin frame is formed to have a plate shape and a frame shape by using a thermoplastic resin, and seals between the anode separator and the cathode separator in a condition where the membrane electrode assembly is held in a central region thereof. As the resin frame, for example, a resin such as PE, PP, PET, PEN can be used. The resin frame may be a three-layer sheet composed of three layers in which an adhesive layer is disposed on a surface layer.

The cooling system supplies cooling water to the fuel cell as a cooling medium.

The cooling water may be water, ethylene glycol, or the like, or a mixture thereof.

The cooling system includes a cooling water pump and a reserve tank, and may include a cooling flow path, a radiator, a bypass flow path, a rotary valve, an ion exchanger, an intercooler, and the like as necessary.

The cooling water pump circulates cooling water for cooling the fuel cell and adjusts a flow rate of the cooling water supplied to the fuel cell.

The reserve tank is a tank for temporarily storing cooling water overflowing from a cooling channel whose internal pressure has increased due to an increase in temperature of the cooling water.

The cooling flow path is a flow path for circulating cooling water for cooling the fuel cell inside and outside the fuel cell.

The radiator is disposed on the cooling flow path and cools the cooling water.

The bypass flow path branches from the cooling flow path upstream of the radiator of the cooling flow path, bypasses the radiator, and merges with the cooling flow path downstream of the radiator of the cooling flow path.

The rotary valve is arranged at a branch point from the cooling flow path to the bypass flow path. The rotary valve performs flow path switching to switch whether the cooling water discharged from the fuel cell flows to the radiator or flows to the bypass flow path. The rotary valve may include an electric motor such as an electric actuator for switching the flow path.

The oxidizing gas system supplies an oxidizing gas to the fuel cell and adjusts a flow rate of the oxidizing gas. The oxidant gas system may include an oxidant gas supply device, an oxidant gas pipe, an inlet-side sealing valve at an oxidant gas inlet of the fuel cell, an outlet-side sealing valve at an oxidant gas outlet of the fuel cell, and the like.

The oxidant gas supply device may be an air compressor or the like.

The fuel gas system supplies fuel gas to the fuel cell and regulates a flow rate of the fuel gas.

The fuel gas system may include a fuel gas tank, a fuel gas inlet valve, an injector, a gas-liquid separator, an exhaust water valve, an ejector for circulating fuel gas, a fuel gas pump for circulating fuel gas, a fuel gas pipe, and the like.

The fuel cell system may include a secondary battery.

The secondary battery may be any battery that can be charged and discharged, and examples thereof include a nickel-hydrogen secondary battery and a conventionally known secondary battery such as a lithium-ion secondary battery. The secondary battery may include a power storage element such as an electric double layer capacitor. The secondary battery may have a configuration in which a plurality of the secondary batteries are connected in series. The secondary battery supplies electric power to an air compressor or the like. The secondary battery may be rechargeable from an external power source of the fuel cell system, such as a household power source. The secondary battery may be charged by the output of the fuel cell. The charging and discharging of the secondary battery may be controlled by the control device.

The fuel cell system includes a control device. The control device may control the entire fuel cell system by controlling the oxidant gas system, the fuel gas system, the cooling system, and the like.

The control device physically includes, for example, an arithmetic processing unit such as a CPU (central processing unit), a ROM (read-only memory) that stores control programs and control data to be processed by CPU, a storage device such as a RAM (random access memory) that is mainly used as various working areas for the control processing, and an input/output interface, and may be an ECU (electronic control unit).

When the temperature of the cooling water is equal to or lower than the low-temperature determination threshold value, the control device performs temperature raising control for raising the temperature of the cooling water to a target temperature. In order to control the reference pressure of the cooling system, the control device temporarily raises the temperature of the cooling water to the target temperature.

In the temperature raising control, a heater may be provided at an arbitrary position of the cooling system, and the temperature of the cooling water may be raised by the heater.

After the temperature increase control, the control device cools the cooling water to a normal use temperature lower than the target temperature.

The target temperature may be higher than the normal use temperature. The target temperature is set based on at least one of a withstand pressure of the cooling system and an operating pressure of the reserve tank.

The low-temperature determination threshold value may be set based on at least one of the withstand pressure of the cooling system and the operating pressure of the reserve tank, or may be lower than the freezing point.

The withstand pressure of the cooling system may be set by preliminarily preparing a data group relating to the withstand pressure and referring to the data group relating to the withstand pressure.

The operating pressure of the reserve tank may be set based on the withstand pressure of the cooling system by preparing in advance a data group indicating a relationship between the withstand pressure of the cooling system and the operating pressure of the reserve tank.

The fuel cell system may comprise a temperature sensor.

The temperature of the cooling water may be measured by a temperature sensor.

The control device may determine whether the temperature of the cooling water measured by the temperature sensor is equal to or lower than a low-temperature determination threshold value.

The control device may perform the temperature rise control when the temperature of the cooling water measured by the temperature sensor is equal to or lower than the low-temperature determination threshold value.

The control device may determine whether or not the temperature of the cooling water measured by the temperature sensor is equal to or lower than the low-temperature determination threshold at the time of starting the fuel cell system or at all times.

The control device may monitor a temperature history of the temperature of the cooling water.

The control device may perform the temperature rise control when the temperature history becomes equal to or lower than the low-temperature determination threshold value.

The control device may comprise a temperature monitor for monitoring the temperature of the cooling water.

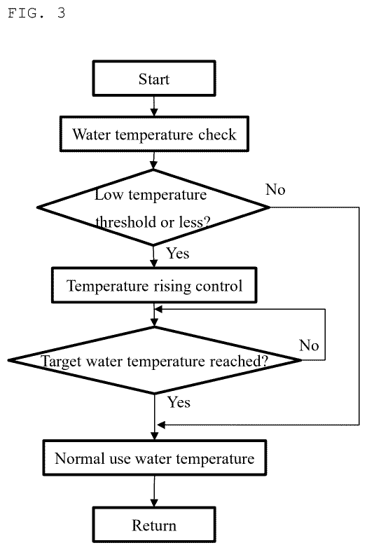

FIG. 2 is a flowchart illustrating an example of control of the fuel cell system of the present disclosure.

The control device performs temperature rise control and intentionally raises the temperature of the cooling water to a target temperature (target water temperature).

The control device determines whether or not the temperature of the cooling water has reached the target temperature.

After determining that the temperature of the cooling water has reached the target temperature, the control device cools the temperature of the cooling water to the normal use temperature and shifts to the normal operation of the fuel cell.

FIG. 3 is a flowchart illustrating another example of control of the fuel cell system of the present disclosure.

The control device monitors the temperature history of the temperature of the cooling water (confirms the water temperature).

The control device determines whether the temperature of the cooling water measured by the temperature sensor is equal to or lower than a low-temperature determination threshold value.

When it is determined that the temperature history exceeds the low-temperature determination threshold value, the control device does not perform the temperature rise control and sets the temperature of the cooling water to a normal use temperature.

On the other hand, when it is determined that the temperature history is equal to or lower than the low-temperature determination threshold value, the control device performs temperature rise control to raise the temperature of the cooling water to the target temperature.

The control device determines whether or not the temperature of the cooling water has reached the target temperature.

After determining that the temperature of the cooling water has reached the target temperature, the control device cools the temperature of the cooling water to the normal use temperature, shifts to the normal operation of the fuel cell, and ends the control. After completion of the control, the low-temperature determination may be repeatedly performed.

As a result, unnecessary temperature rise control can be avoided, which is excellent in terms of efficiency of the fuel cell system and durability of the fuel cell.

1. A fuel cell system,
wherein the fuel cell system comprises a fuel cell, a cooling system and a control device;
wherein the cooling system comprises a cooling water pump and a reserve tank;
wherein, when a temperature of cooling water is equal to or lower than a low-temperature determination threshold value, the control device is configured to perform temperature increase control for increasing the temperature of the cooling water to a target temperature;
wherein, after the temperature increase control, the control device is configured to cool the temperature of the cooling water to a normal use temperature lower than the target temperature; and
wherein the target temperature is set based on at least one of a pressure resistance of the cooling system or an operating pressure of the reserve tank.

2. The fuel cell system according to claim 1,
wherein the control device is configured to monitor a temperature history of the temperature of the cooling water, and
wherein, when the temperature history becomes equal to or lower than the low-temperature determination threshold value, the control device is configured to perform the temperature raising control.
